(19) United States
(12) Patent Application Publication
(10) Pub. No.: US 2015/0165534 A1
(43) Pub. Date: Jun. 18, 2015

(54) THREAD FORMING USING AN IMPACT DRIVER

(71) Applicant: Ridge Tool Company, Elyria, OH (US)

(72) Inventor: James E. Hamm, Grafton, OH (US)

(73) Assignee: Ridge Tool Company, Elyria, OH (US)

(21) Appl. No.: 14/105,602

(22) Filed: Dec. 13, 2013

(51) Int. Cl. B23G 1/52; B23G 1/24; B23G 3/00

(52) U.S. Cl. CPC B23G 1/52; B23G 3/00; B23G 1/24; B23G 2240/00

(57) ABSTRACT

Systems and methods for forming threads in workpieces such as along pipe ends using impact drivers are described. Using an impact driver during thread forming significantly reduces reaction torque which must otherwise be countered by a user or by using affixment devices such as vises.

### FIELD

The present subject matter relates to systems and methods for forming threads using impact drivers. The subject matter also relates to adapters for use with impact drivers and thread forming dies.

### BACKGROUND

A variety of techniques are known for forming helical screw threads on workpieces such as pipes or mechanical components. Subtractive methods involve thread cutting using taps or dies. Taps are typically used to form internal threads along the interior surface of an opening or blind hole. Dies are typically used to form external threads along outer surfaces of workpieces such as pipes or other cylindrical components. Single point tools are also known which can be used to form threads.

When forming threads and particularly in relatively hard materials and/or on workpieces such as pipes, large floor-standing threading machines are frequently used. This is primarily so that the relatively high levels of torque required for thread forming can be controllably applied to the workpiece or the thread forming die. This is also due to the relatively high reaction torque resulting from thread forming. As torque is applied by the machine during a thread forming operation on a pipe end, a resulting reaction torque experienced at the drive and/or at the pipe is countered by the machine frame and/or by engagement between the pipe and the machine.

Threads can also be formed without using such large floor-standing machines. For example, handheld powered drives are known which can be used with one or more die heads to form threads on a pipe end. It is still necessary to counter resulting reaction torque. This can be achieved for example by securing the pipe in a vise or other affixment assembly so that an operator can apply a force to counter the resulting reaction torque such as when using a handheld powered drive. In certain situations such as when using a handheld powered drive, support arms or other handle members are used on the pipe so that the support arm can exert the requisite force to counter the reaction torque.

A need remains for a new strategy for forming threads which avoids the relatively high reaction torque resulting from conventional thread forming techniques and equipment. In particular, it would be desirable to provide a method for forming external threads on workpieces such as pipes which did not produce relatively high reaction torque or associated forces.

### SUMMARY

The difficulties and drawbacks associated with previously known processes for forming threads and threading equipment are addressed in the present methods and systems for forming threads on workpieces such as pipes.

In one aspect, the present subject matter provides a method of forming an external helical screw thread along an arcuate surface of a workpiece. The method comprises providing a workpiece defining an end and an outer arcuate surface proximate the end. The method also comprises defining a center axis about which the helical screw thread is to be formed in the workpiece. The method additionally comprises providing an impact driver including a rotatable output anvil shaft that rotates upon impact from a rotating hammer mass. The method further comprises providing a thread forming die sized and configured to form the external helical screw thread. In certain versions of the present subject matter, the thread forming die is engageable with the output shaft of the impact driver. The method also comprises positioning the die into thread forming engagement with the end of the workpiece. And, the method comprises rotating at least one of the die and the workpiece about the center axis using the impact driver to thereby form an external helical screw thread along the arcuate surface of the workpiece.

In another aspect, the present subject matter provides a system for forming an external helical screw thread along an arcuate surface. The system comprises an impact driver including a rotatable output anvil shaft that rotates upon impact from a rotating hammer mass. The system also comprises a thread forming die sized and configured to form the external helical screw thread. The thread forming die is engageable with the output shaft of the impact driver.

In yet another aspect, the present subject matter also provides an adapter for axial transmission of torque to a thread forming die head. The adapter comprises an end plate having coupling provisions for engaging a thread forming die head. The adapter also comprises a drive receptacle sized and shaped to releasably engage an output anvil shaft of an impact driver. The adapter additionally comprises a body extending between the end plate and the drive receptacle. The end plate defines a front face and an oppositely directed rear face and the coupling provisions include a plurality of elongated openings extending through the end plate between the front face and the rear face.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic rear perspective view of a threading adapter in accordance with the present subject matter.

FIG. 2 is a schematic side view of the adapter depicted in FIG. 1.

FIG. 3 is a schematic rear end view taken from line III-III shown in FIG. 2.

FIG. 4 is a schematic view of a system for forming threads on a workpiece in accordance with the present subject matter.

FIG. 5 is a detailed schematic partial cross sectional view illustrating in greater detail an adapter, die head, and workpiece of FIG. 4.

FIG. 6 is a graph of a representative torque profile of a typical impact driver.

### DETAILED DESCRIPTION OF THE EMBODIMENTS

Impact drivers or tools for use with fasteners such as nuts or bolts are typically driven by air or electric motors. An impact tool is one in which an output shaft (commonly referred to as an “anvil”) is struck by a rotating mass (commonly referred to in the art as a “hammer”). The output shaft is coupled to the fastener to be tightened or loosened, and each strike of the hammer on the anvil applies torque to the fastener. Because of the nature of impact loading compared to constant loading, an impact tool can deliver a relatively high torque, as high as a typical corresponding constant drive, but with a significantly lower reaction torque.

Another aspect of impact drivers and particularly when compared to powered drives that provide a relatively constant drive, e.g., an electric motor, is that impact drivers produce significantly lower levels of reaction torque than corresponding constant drives.

The present subject matter provides the use of an impact driver in systems and methods of forming threads, and particularly external threads, on workpieces. The present subject matter also provides adapters enabling use of impact drivers with a variety of thread forming dies. These and other aspects are all described in greater detail herein.

### Impact Drivers

As known in the industry, an impact driver provides a relatively high speed repetitive turn-stop-turn-stop motion. This allows the impact driver to provide a significantly higher level of torque than a comparable constant drive device, with significantly lower levels of reaction torque that must otherwise be countered by an operator or by a machine frame or support structure.

The present subject matter can utilize a variety of different types of impact drivers. For example, the present subject matter can utilize pneumatically powered impact drivers, electrically powered impact drivers, or hydraulically powered impact drivers. The present subject matter can utilize nearly any type of impact driver. For most versions of the present subject matter, the impact driver is electrically powered.

A wide array of impact drivers are known which employ different mechanisms and assemblies for achieving the characteristic impact loading or delivery of forces. The present subject matter can utilize nearly any type of impact driver mechanism so long as the impact driver includes a rotatable output shaft or “anvil shaft” that rotates upon impact from a rotating mass or “hammer.” Nonlimiting examples of representative impact drivers include those described in U.S. Pat. Nos. 8,430,185; 7,562,720; 6,223,834; 5,848,655; 2,196,589; and 2,049,273.

The impact driver used in accordance with the present subject matter can be nearly any size so long as the driver is able to provide the requisite level of torque needed for the threading operation. Typically, the impact driver includes a ⅜ inch, ½ inch, ¾ inch, 1 inch, or1½ inch square drive as known in the art. The impact driver can utilize other drive or engagement configurations such as a ¼ inch hex drive, other size hex drive, or a splined configuration.

In certain embodiments of the present subject matter, the impact driver exhibits particular operational characteristics such as those set forth below in Table 1 for a typical ½ inch impact driver.

TABLE 1
Typical Impact Driver Operational Characteristics

| Parameter | Typical | Particular |
|---|---|---|
| Beats/Hammer strikes per minute | At least 200 | At least 1,000 |
| Free speed (RPM) | At least 1,000 | At least 1,500 |
| Maximum Torque (foot pounds) | At least 100 | At least 200 |

The beats or hammer strikes per minute is also known in the art “as impacts per minute.” The free speed is also known in the art as “no load speed.” It will be appreciated that the present subject matter includes a wide array of impact drivers and is not limited to impact drivers having the operational characteristics noted in Table 1.

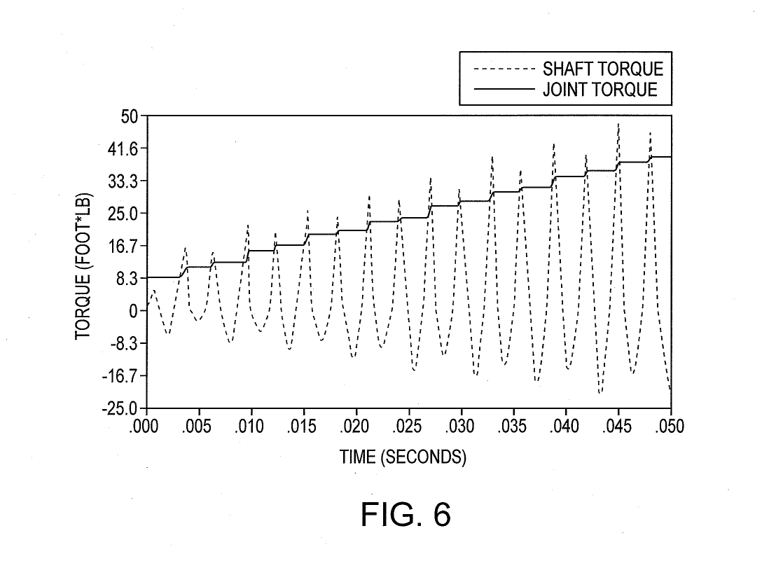

Impact drivers produce a powered rotary output, i.e., a torque profile, which can be characterized as a series of torque “spikes” that result in a successively accumulating or increasing amount of applied torque. FIG. 6 is a representative graph of applied torque (see “joint torque”) upon a fastener provided by an impact driver. As shown, a series of hammer strikes on an anvil shaft (see “shaft torque”) results in a rapidly increasing applied torque at a joint or fastener for example of about 38 foot-pounds at 0.050 seconds. It will be appreciated that FIG. 6 is merely representative and in no way limits the present subject matter.

### Threads

Generally, the present subject matter is directed to methods of forming external threads. Forming external threads along arcuate surfaces of workpieces, i.e., outwardly curved surfaces, presents different considerations, technical difficulties, and involves different objectives than forming internal threads such as along inner walls, i.e., inwardly curved surfaces, of a bore or blind hole in a workpiece. Thus, the term “external threads” as used herein refers exclusively to threads formed along outer surfaces of workpieces such as pipe ends or mechanical fasteners; and the term does not include previously noted internal threads. However, the term “external threads” includes various thread configurations such as straight threads, tapered threads, and threads as specified as British Standard Pipe Threads (BSPT) and National Pipe Threads (NPT).

### Thread Forming Dies

The present subject matter can be used in conjunction with nearly any type of thread forming or thread cutting die. The present subject matter also relates to thread freshening tools and thread cleaning operations. Typically, a thread forming die for forming external threads on a workpiece includes a housing or body having one or more thread cutting blades, tools, or chasers as known in the art. Nonlimiting examples of patents describing thread forming dies include U.S. Pat. Nos. 4,743,146; 2,014,312; and 2,054,745.

### Reaction Torque

As previously noted, a significant difference between impact drivers and constant drives is that impact drivers produce significantly lower levels of reaction torque as compared to constant drives for similarly sized and configured systems. For example, when forming external tapered threads (i.e., NPT) along an end of a 1 inch diameter pipe using a constant drive, typical reaction torque observed during the operation is about 125 foot pounds. In contrast, in accordance with the present subject matter and when forming external tapered threads using an impact driver along an end of a 1 inch diameter pipe, the observed reaction torque is less than 25 foot pounds and typically less than 10 foot pounds. Moreover, when forming external tapered threads using an impact driver along an end of a ¾ inch pipe, the observed reaction torque is less than 20 foot pounds and typically less than 10 foot pounds. In addition, when forming external tapered threads using an impact driver along an end of a ½ inch pipe, the observed reaction torque is less than 15 foot pounds and typically less than 10 foot pounds.

Table 2 set forth below lists representative reaction torque levels encountered during threading operations using a conventional constant drive and an impact driver in accordance with the present subject matter. As will be appreciated, use of an impact driver in threading operations results in significantly lower levels of reaction torque as compared to using a constant drive.

TABLE 2
Comparison of Reaction Torques During
Threading Using Different Drives

| | | Typical Reaction |
|---|---|---|
| | Typical Reaction Torque | Torque Encountered |
| Forming External | Encountered Using Impact | Using Constant |
| Thread on Pipe | Driver (foot pounds) | Drive (foot pounds) |
| ½ inch | less than 10 | 60 |
| ¾ inch | less than 10 | 70 |
| 1 inch | less than 10 | 130 |

### Methods

The present subject matter also provides a variety of methods for threading using impact drivers. Specifically, the subject matter provides a method of forming an external helical screw thread along an arcuate surface of a workpiece such as a pipe for example. The method comprises providing a workpiece defining an end and an outer arcuate surface proximate the end. The outer arcuate surface is typically an outer circumferential surface adjacent to or near the end of the workpiece. The method also comprises defining a center axis about which the external helical screw thread is to be formed in the workpiece. The method additionally comprises providing an impact driver including a rotatable output anvil shaft that rotates upon impact from a rotating hammer mass. The method further provides providing a thread forming die sized and configured to form the helical screw thread. The thread forming die is engageable with the output shaft of the impact driver. The method also comprises positioning the die into thread forming engagement with the end of the workpiece. When positioning the die and/or workpiece, typically the components are axially displaced toward one another. And, the method comprises rotating at least one of the die and the workpiece about the center axis using the impact driver to thereby form an external helical screw thread along the arcuate surface of the workpiece. As will be appreciated, prior to, during, or after initiation of such rotating, contact is established between the die and the workpiece.

In specifying particular parameters for threading workpieces in accordance with the present subject matter, the requisite torque needed depends upon several factors such as workpiece material, thread size, and workpiece size for example. The speed or rate of rotation for the dies and/or workpiece is typically within a range of from about 5 RPM up to about 120 RPM, with many threading operations performed using a threading speed of from about 20 RPM to about 60 RPM, and more particularly from about 20 RPM to 40 RPM. It will be understood that these parameters are merely for illustration and in no way limit the scope of the present subject matter.

### Threading Adapter

In another aspect, the present subject matter also provides an adapter that can be used in conjunction with one or more standard or conventional thread forming dies or die heads. The adapter enables axial transmission of torque to the die head from an impact driver. The adapter also enables the die head to be used in relatively small work spaces, and particularly those in which a conventional power drive unit may not be usable. The adapter is appropriately sized and includes provisions that enable the adapter to accommodate a range of different size die heads. For example, in certain embodiments, a collection of engagement members slidably mounted in radially oriented slots in the adapter can be used to enable the adapter to be used with one of many different size die heads. It will be appreciated that the present subject matter includes a wide array of adapter structures and configurations and is not limited to the versions described herein.

In certain embodiments, one or more fasteners are used to affix or otherwise couple the adapter to the die head. The fasteners or fastener assembly can be in a variety of different shapes and configurations. A representative example is a threaded fastener such as a bolt and a threaded engagement member such as a nut or the like. In certain applications, the die head can include threaded bores that receive the threaded fasteners, and thus engagement members such as nuts are not required. The present subject matter also includes adapters that can be affixed or coupled to a die head without the use of threaded fasteners.

In certain embodiments of the present subject matter, key or other interlocking engagement provisions can be used to promote or facilitate engagement between the adapter and a die head. Such key provisions promote transfer of torque to the die head. For example, a 12R die head commercially available under the Ridgid® designation from Ridge Tool Company includes a plurality of axially extending members which receive and retain the thread forming dies. A threading adapter in accordance with the present subject matter can include receiving regions along its outer axial face that engage the die retaining members of the 12R die head. The engagement interface between the adapter and the die head constitutes the key provisions.

A rear face of the adapter includes a square drive receptacle corresponding to conventional ½ inch or ¾ inch drives or other sizes such as those used with currently available impact drivers or handheld ratchet or socket wrenches. It will be understood that the rear face of the adapter can include nearly any size or type of drive receptacle to enable engagement between the adapter and the impact driver of interest.

As previously noted, the present subject matter relates to the use of a powered impact driver to rotate the adapter such as during a thread forming operation. The adapter could also be used in a manual mode in which the adapter (and associated die head) is rotated using a ratchet wrench or other operator powered tool.

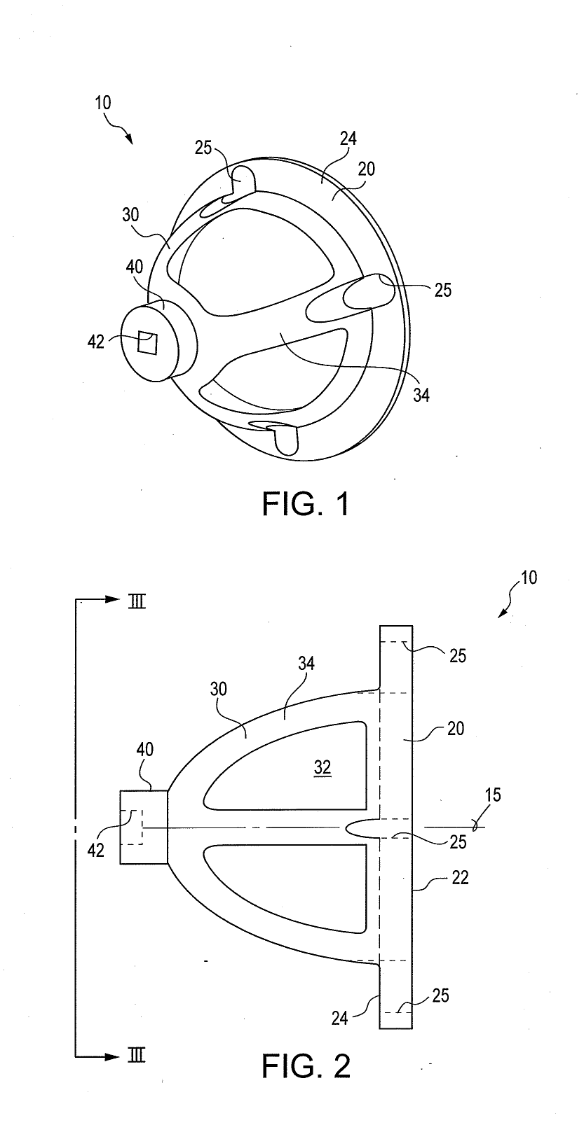

FIGS. 1-3 schematically depict an adapter in accordance with the present subject matter. Specifically, the adapter 10 comprises an end plate 20, a drive receptacle 40, and a body or housing 30 extending between the end plate 20 and the drive receptacle 40. The end plate 20 can be provided in a variety of shapes and configurations. However, in the embodiment shown in the referenced figures, the end plate 20 is circular and defines a front face 22 and an oppositely directed rear face 24. The plate 20 also defines a plurality of openings 25 extending between the faces 22 and 24. The openings 25 can be any shape and size, however, are typically elongated or slotted in shape as described herein. The body 30 may be enclosed or include one or more openings or access regions 32 defined between support members 34. The drive receptacle 40 is centrally located relative to the plurality of openings 25 and defines an engagement region 42 sized and shaped to releasably engage a conventional square drive typically provided on impact drivers. The adapter 10 defines a central axis 15, addressed in greater detail herein.

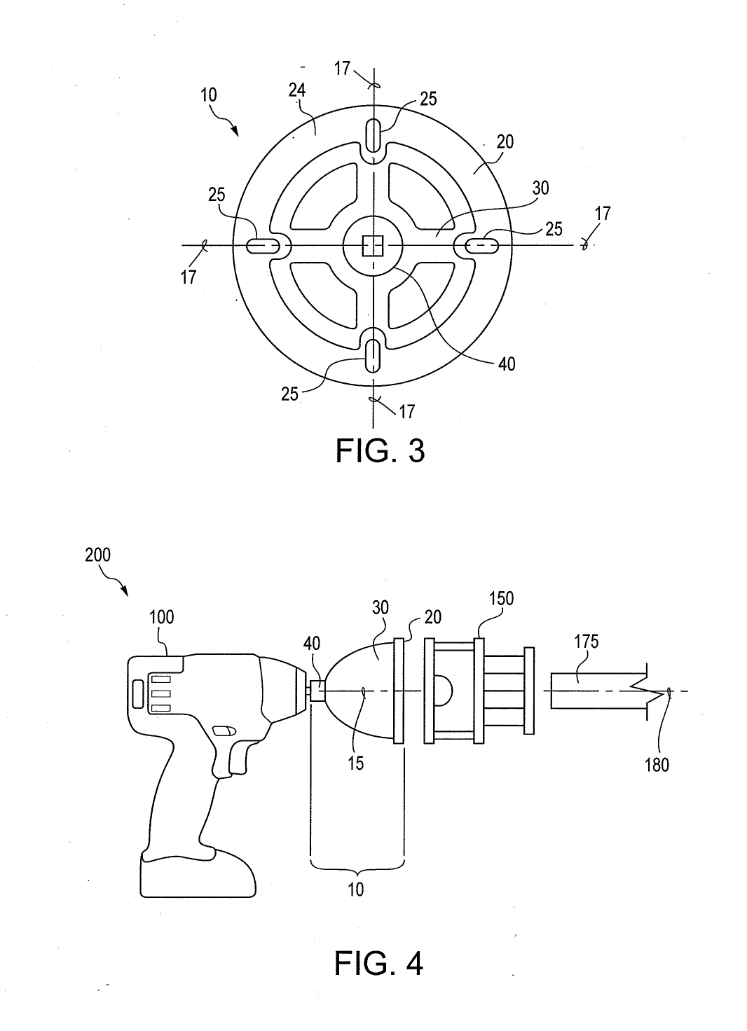

In certain embodiments, the end plate 20 includes coupling provisions in the form of a plurality of elongated openings 25 extending through the end plate between the inner face and the outer face. Each of the openings 25 if elongated, defines a major axis such as major axis 17 depicted in FIG. 3 which is radially aligned with the central axis 15 of the adapter 10.

In the event that threaded fasteners are used to affix the adapter 10 to the die head, the fasteners extend through the openings 25. Upon threaded engagement with threaded bores in the die head or with threaded engagement members such as nuts, the adapter and die head are affixed or otherwise coupled together.

The adapter 10 is formed from materials sufficiently strong and rigid to transfer the relatively high levels of torque and withstand the relatively high frequency of impact loading associated with impact drivers. Nonlimiting examples of such materials include hardened steels such as 4140 steel.

### Systems

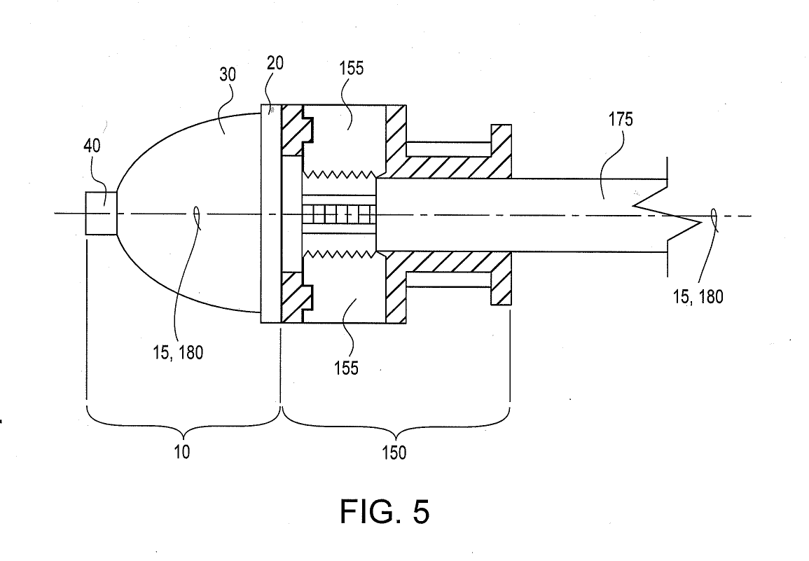

FIGS. 4 and 5 schematically illustrate a system 200 for forming threads on a pipe or other workpiece in accordance with the present subject matter. Specifically, the system 200 comprises an impact driver 100 as described herein, a thread forming die or die head as described herein and schematically depicted as item 150, and an adapter disposed therebetween such as the previously noted adapter 10. The die head 150 includes one or more threading dies 155. The impact driver 100, the adapter 10, and the die head 150 are coupled or otherwise engaged to one another and then oriented or aligned with a center axis 180 of a workpiece 175 which may be a pipe for example. Specifically, the center axis 15 of the adapter 10 is aligned with the center axis 180 of the workpiece 175. The impact driver 100 is actuated to thereby rotate the adapter 10 and the die head 150. The rotating die head 150 is contacted with an end or region of the workpiece 175 in which thread(s) are to be formed. Axial force applied to the die head 150 toward the workpiece 175, and contact between the threading dies 155 and the workpiece during rotation of the die head 150 results in forming threads in the workpiece 175.

### Examples

Investigations were conducted to evaluate and compare typical reaction torques experienced during threading of pipes having various diameters using several commercially available die heads and power drives as compared to threading in accordance with the present subject matter using impact drivers.

Specifically, three power drives available from Ridge Tool Company were used in conjunction with Ridgid® 12R die heads. Two types of external threads, i.e., NPT threads and BSPT threads, were formed using threading dies in the various pipes noted in Table 3 below. During threading of each pipe, minimum and maximum threading torque values were measured. Low torque values, high torque values, and overall average torque values associated with each pipe diameter were determined and are set forth in Table 3.

TABLE 3
Threading Torque Values During Threading Using Power Drives

| | | | | | Calculated |
|---|---|---|---|---|---|
| | | Data BSPT | Data NPT | Data NPT | Overall |
| | Data BSPT | High | Low | High | Average |
| Pipe | Low Torque | Torque | Torque | Torque | Torque |
| Size | (ft-lbs) | (ft-lbs) | (ft-lbs) | (ft-lbs) | (ft-lbs) |
| ¼″ | 20 | 25 | — | — | 22.5 |
| ⅜″ | 25 | 40 | 30 | 35 | 32.5 |
| ½″ | 45 | 55 | 30 | 100 | 57.5 |
| ¾″ | 65 | 80 | 50 | 70 | 66.25 |
| 1″ | 85 | 200 | 90 | 120 | 123.75 |
| 1¼″ | 140 | 210 | 130 | 260 | 185 |
| 1½″ | 175 | 245 | 175 | 270 | 216.25 |
| 2″ | 230 | 300 | 310 | 390 | 307.5 |

For the torque values noted in Table 3, the low and high torque values were obtained using the noted Ridgid® 12R die heads. All drop head die heads use the same type of dies.

Corresponding impact tools were obtained, namely from Milwaukee Tools under the designation 2662-20, DeWalt Tools under the designation DW-292, and Ingersoll-Rand under the designation W360. The maximum torque rating for each impact tool was identified from information by its supplier. Next, handle reaction force was measured for each impact tool at maximum torque output. Reaction lengths of the various impact tools were in a range of 4 inches to 5 inches. An average of 4.5 inches was used. The calculated torque was then determined. This data is summarized in Table 5. As shown in Table 5, the measured handle force and calculated reaction torque are very low in comparison to the maximum torque rating for each impact driver.

TABLE 5
Maximum Impact Tool Torque Ratings, Handle
Reaction Force, and Calculated Reaction Torque
At Maximum Impact Tool Torque Output

| | | Measured Handle | |
|---|---|---|---|
| | Manufacturer | Force at Max. | Calculated |
| Impact Tool | Max. Torque | Torque | Reaction Torque |
| Brand | Rating (ft-lbs) | Output (lbs) | (ft-lbs) |
| Milwaukee | 450 | 20 | 7.5 |
| Dewalt | 345 | 14 | 5.25 |
| Ingersoll-Rand | 360 | 9 | 3.375 |
| Average | — | 14.3 | 5.4 |

Generally, for a pipe size of about ½ inch to about ¾ inch, the torque that a user experiences during impact threading is typically less than 25%, and in many embodiments less than 15% as compared to the torque experienced with a conventional power drive. During threading of larger diameter pipes, the torque that a user experiences during impact threading is less than 25% and in many instances, less than 15% and even less than 10% as compared to the torque encountered when using a conventional power drive. Use of an impact drive in a threading operation significantly reduces torque that an operator must counter.

As previously noted, depending upon the parameters of a particular operation, e.g., the pipe diameter, when utilizing a commercially available power drive an additional support arm may be used in conjunction with the power drive. This assists an operator in countering the relatively large reaction force(s) exhibited at the power drive handle which may be in a range of 60 to 70 pounds or more for pipes having diameters of ¾ inch to 1 inch. Reaction forces at a power drive handle can be significantly greater when threading pipes having larger diameters such as1¼ inch, 1½ inch, and 2 inches. Use of an impact driver would eliminate or at least significantly reduce the need for support arms or similar components to assist an operator when threading.

Although the present subject matter has been described in terms of forming threads on cylindrical workpieces such as pipes, it will be understood that the present subject matter can be applied to a wide array of other workpiece shapes and configurations. For example, the present subject matter can be performed upon cone shaped workpieces or other noncylindrical shapes.

Many other benefits will no doubt become apparent from future application and development of this technology.

All patents, published applications, and articles noted herein are hereby incorporated by reference in their entirety.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A method of forming an external helical screw thread along an arcuate surface of a workpiece, the method comprising:
providing a workpiece defining an end and an outer arcuate surface proximate the end;
defining a center axis about which the external helical screw thread is to be formed in the workpiece;
providing an impact driver including a rotatable output anvil shaft that rotates upon impact from a rotating hammer mass;
providing a thread forming die sized and configured to form the external helical screw thread;
positioning the die into thread forming engagement with the end of the workpiece;
rotating at least one of the die and the workpiece about the center axis using the impact driver to thereby form an external helical screw thread along the arcuate surface of the workpiece.

2. The method of claim 1 wherein the thread forming die is engageable with the output shaft of the impact driver.

3. The method of claim 1 wherein the impact driver is electrically powered.

4. The method of claim 1 wherein the outer arcuate surface is cylindrical in shape.

5. The method of claim 1 wherein the screw thread is a straight thread.

6. The method of claim 1 wherein the screw thread is a tapered thread.

7. The method of claim 1 wherein the impact driver provides at least 200 impact strikes per minute.

8. The method of claim 1 wherein the impact driver provides a free speed of at least 1,500 RPM.

9. The method of claim 1 wherein the impact driver provides a maximum torque of at least 100 foot pounds.

10. The method of claim 9 wherein the impact driver provides a maximum torque of at least 200 foot pounds.

11. The method of claim 1 wherein the screw thread is a tapered thread, the workpiece is a 1 inch diameter pipe, and a maximum reaction torque during the rotating is less than 25 foot pounds.

12. The method of claim 1 wherein the screw thread is a tapered thread, the workpiece is a ¾ inch diameter pipe, and a maximum reaction torque during the rotating is less than 20 foot pounds.

13. The method of claim 1 wherein the screw thread is a tapered thread, the workpiece is a ½ inch diameter pipe, and a maximum reaction torque during the rotating is less than 15 foot pounds.

14. The method of claim 1 further comprising:
providing an adapter having a drive receptacle and coupling provisions for engaging a thread forming die;
locating and engaging the adapter between the impact driver and the thread forming die whereby the drive receptacle of the adapter is engaged with the output anvil shaft of the impact driver and the coupling provisions of the adapter are engaged with the thread forming die.

15. A system for forming an external helical screw thread along an arcuate surface, the system comprising:
an impact driver including a rotatable output anvil shaft that rotates upon impact from a rotating hammer mass; and
a thread forming die sized and configured to form the external helical screw thread, the thread forming die engageable with the output shaft of the impact driver.

16. The system of claim 15 further comprising:
an adapter having a drive receptacle sized and shaped to engage the output anvil shaft of the impact driver, and coupling provisions for engaging the thread forming die.

17. An adapter for axial transmission of torque to a thread forming die head, the adapter comprising:
an end plate having coupling provisions for engaging a thread forming die head;
a drive receptacle sized and shaped to releasably engage an output anvil shaft of an impact driver;
a body extending between the end plate and the drive receptacle;
wherein the end plate defines a front face and an oppositely directed rear face and the coupling provisions include a plurality of elongated openings extending through the end plate between the front face and the rear face.

18. The adapter of claim 17 wherein each of the elongated openings defined in the end plate defines a major axis, and each of the major axes of the openings is radially aligned with a center axis of the adapter.
